(19) United States
(12) Patent Application Publication
(10) Pub. No.: US 2014/0244392 A1
(43) Pub. Date: Aug. 28, 2014

(54) Graphical Recognition Inventory Management and Marketing System

(71) Applicant: XUE SI XING DIGITAL MARKETING CO., LTD., Taipei City (TW)

(72) Inventor: Terry Chang, Taipei City (TW)

(73) Assignee: XUE SI XING DIGITAL MARKETING CO., LTD., Taipei City (TW)

(21) Appl. No.: 13/779,455

(22) Filed: Feb. 27, 2013

(51) Int. Cl. G06Q 10/08

(52) U.S. Cl. CPC G06Q 10/087
USPC 705/14.58; 705/28; 705/26.8

(57) ABSTRACT

A graphical recognition inventory management and marketing system is disclosed. An image comprising a plurality of product elements is captured. Graphical recognition is utilized to detect, isolate, and identify each element by comparing characteristics of the element with element data stored in a database. When a match is found, the detected and isolated element data is stored with the matched database entry. Additional element data obtained during the graphical recognition process is added to element data stored in the database to expand the database entry. The current location of a user device is detected and product element data is displayed along with a map indicating the physical location of the product element and a route to the product element from the user's current location. A user can also capture an image and have product data and a map to the product displayed.

### BACKGROUND OF THE INVENTION

1. Field of the Invention

The present invention relates to graphical recognition. More specifically, the present invention discloses an effective system utilizing graphical recognition technology to efficiently improve inventory management operations and shelf picking and assists consumers with shopping in physical stores.

2. Description of the Prior Art

For a large e-commerce shopping site a large number and wide variety of products must be stocked in a warehouse. As consumer demand increases for niche items an ever increasing number of products must be stored in inventory and warehouse space must be expanded. Therefore, when an inventory is performed workers must spend an increasing amount of time counting products. Additionally, when orders are filled workers must spend more time picking the products from the warehouse shelves. As a result, the conventional warehouse inventory and order fulfillment processes are time consuming and costly.

Since a warehouse has numerous shelves and a typical warehouse shelf contains many different but similar items warehouse workers must not only locate the appropriate shelf in the warehouse where the product is located but as well as identify the specific product from the multiple number of similar products on the shelf.

In the conventional inventory process inventory personnel must locate a barcode on the product, scan the barcode into a computer, and return the product to the shelf. This inefficiency increases operating costs.

Additionally, during the traditional inventory process a freeze is put on all the stock in the warehouse and products cannot be shipped until the inventory has been completed. Also, in a retail store the store must be closed and products on the store shelves cannot be sold while inventory is taken. This freeze on stock results in a decline in service quality and incurs loss of business.

Traditional retail channels rely on sending marketing flyers to attract consumers to visit the physical store to browse and make purchases. While useful to consumers for reference, it is inconvenient for the consumer to carry the flyer to the store or remember which products they intend to purchase. Additionally, consumers spend a lot of time looking for the shelf location where the product is physically located in the store. This inefficiency lowers customer satisfaction.

Therefore, there is need for an improved means of efficiently and economically performing inventory and order fulfilment processes and increasing customer satisfaction while shopping in physical stores.

### SUMMARY OF THE INVENTION

To achieve these and other advantages and in order to overcome the disadvantages of the conventional method in accordance with the purpose of the invention as embodied and broadly described herein, the present invention provides an effective inventory management and marketing system utilizing graphical recognition technology to efficiently improve inventory management operations and shelf picking and assists consumers with shopping in physical stores.

In the present invention graphical recognition technology is coupled with modern management technology to provide an extremely efficient inventory and order fulfillment process.

Periodically photographs or videos are taken of product shelves and the products stored on the shelves. Digital image recognition technology automatically separates and isolates each product captured in the images for identifying the product and obtaining product element data. The recognized product elements and product element data captured by the image capture device is compared with a database via a server. Utilizing the captured recognized product element data accurate product quantity and inventory data is obtained. The obtained data and the stored data in the database are used to perform inventory management, product picking, and ordering processes. Additionally, a map indicating the physical location of each product element is automatically created.

The graphical recognition inventory system of the present invention allows an accurate inventory to be taken with increased efficiency since the product does not need to be moved and scanned for barcode.

Warehouse personnel equipped with an electronic device such as, for example, a tablet computer or a smartphone are provided with a display showing products to be picked to fulfill an order as well as a flow map indicating the physical location of the products on the product shelves in the warehouse. Provided with a picture of the product and a map showing the location of the product, warehouse personnel can quickly and easily pick the products to fulfill an order. As a result, time is saved and operating costs are lowered.

Products with foreign language text typically frustrate and aggravate warehouse personnel who are not fluent in the foreign language and frequently results in inaccurate order fulfillment. However, the present invention leverages optical character recognition (OCR) when recognizing product elements and provides a picture of the product during order picking which eliminates need for the worker to be familiar with the foreign language for inventory and order fulfillment processes.

The graphical recognition inventory management and marketing system also improves customer satisfaction and loyalty. A mobile device application of the present invention is provided to consumers who photograph products they are interested in purchasing. When the consumer's location is detected the mobile application displays product data for the photographed product and the physical location in the store and the route from the user's location to the product's location is displayed. This allows consumers to be reminded of products they want to purchase and allows consumers to easily locate the product in the store.

The present invention detects which products consumers are photographing for marketing and inventory level purposes as well as individual consumer history and preferences.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a drawing illustrating an architecture of a graphical recognition inventory management and marketing system according to an embodiment of the present invention;

FIG. 2 is a drawing illustrating a captured image of a plurality of elements according to an embodiment of the present invention;

FIG. 3 is a flowchart illustrating a graphical recognition inventory management and marketing system according to an embodiment of the present invention;

FIG. 4A is a thawing illustrating an isolated element with vertical text according to an embodiment of the present invention;

FIG. 4B is a drawing illustrating an isolated element with horizontal text according to an embodiment of the present invention;

FIG. 4C is a drawing illustrating an isolated element with rotated text according to an embodiment of the present invention;

FIG. 5 is a drawing illustrating a side and front view of an element according to an embodiment of the present invention;

FIG. 6 is a flowchart illustrating an element recognition procedure according to an embodiment of the present invention;

FIG. 7 is a drawing illustrating a product shelf with shelf location identification according to an embodiment of the present invention;

FIG. 8 is a flowchart illustrating a graphical recognition inventory management and marketing system according to an embodiment of the present invention;

FIG. 9 is a drawing illustrating a product shelf according to an embodiment of the present invention;

FIG. 10 is a thawing illustrating an architecture of a graphical recognition inventory management and marketing system according to an embodiment of the present invention;

FIG. 11 is a flowchart illustrating a graphical recognition inventory management and marketing system according to an embodiment of the present invention;

FIG. 12 is a flowchart illustrating a graphical recognition inventory management and marketing system according to an embodiment of the present invention; and

FIG. 13 is a flowchart illustrating a graphical recognition inventory management and marketing system according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

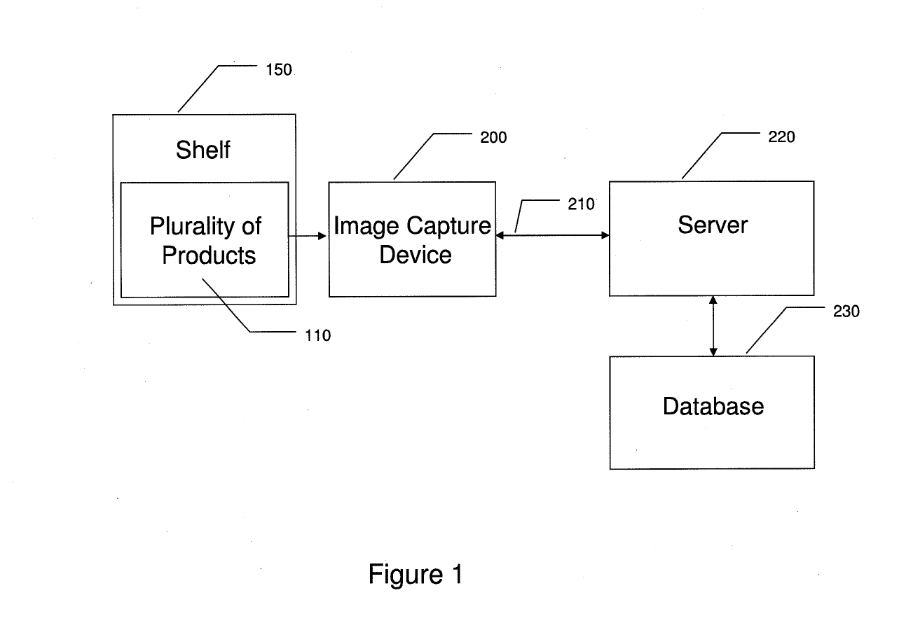

Refer to FIG. 1, which is a drawing illustrating an architecture of a graphical recognition inventory management and marketing system according to an embodiment of the present invention.

A warehouse, wholesale, and retail store each comprise numerous shelves where a wide variety of products are stored. In order to maintain an accurate count of the total number of each product an inventory must be taken periodically.

In the embodiment illustrated in FIG. 1 the graphical recognition inventory management and marketing system comprises a product shelf 150, a plurality of products 110 stored on the product shelf 150, an image capture device 200, a server 220, and a database 230.

The database 230 comprises product element data about each product 110. The product element data comprises, for example, brand name, product name, cost, price, current inventory level, size, shape, dimensions, weight, logo, manufacturer, supplier, color, design, graphics, images, text, total cost of current inventory, shelf location identification(s), product number, barcode, and other data of identifying characteristics of the product 110.

The image capture device 200 takes photographs or videos of the plurality of products 110 stored on the shelf 150. The individual products 110 captured are isolated and recognized to identify the individual product element 110. The database is searched to find a match with the recognized product element 110. When a match is found the recognized product element data is added to the database for the matching database entry. For example, quantities are adjusted or tracked, shelf location is identified, or additional product element data not currently in the database is added to the database entry.

The image capture device 200 communicates with the server 220 via a wireless connection 210.

The isolating and recognition processes are performed on the image capture device 200 or the server 220

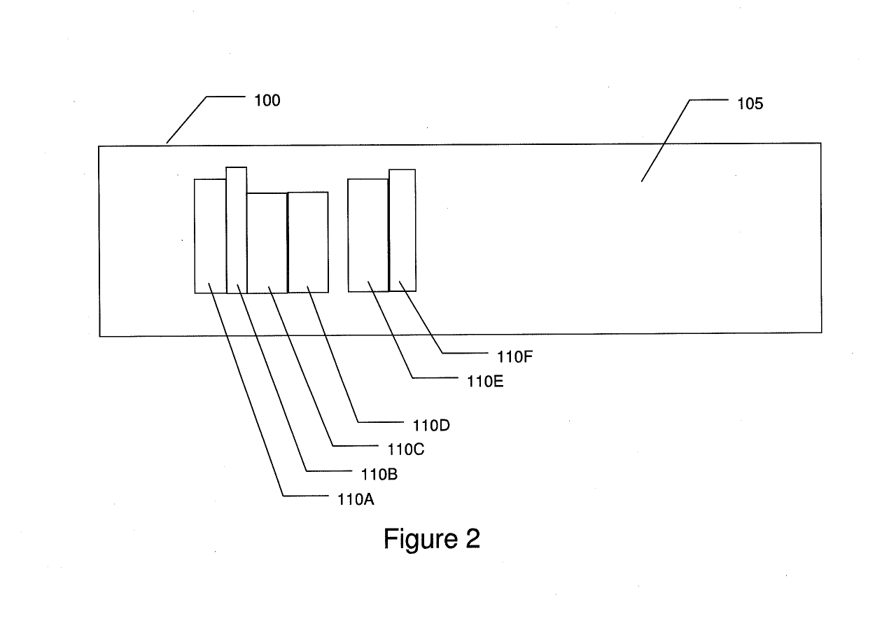

Refer to FIG. 2, which is a drawing illustrating a captured image of a plurality of elements according to an embodiment of the present invention.

The captured image 100 taken by the image capture device comprises a plurality of product elements 110A-110F and non-element areas 105 which do not contain elements.

In order to recognize each of the product elements 110A-11F they are isolated. For example, the image of product element 110A is separated from the other product elements 110B-110F in the captured image 100 by detecting the edges of product element 110A and the non-element area 105 or product element 110B.

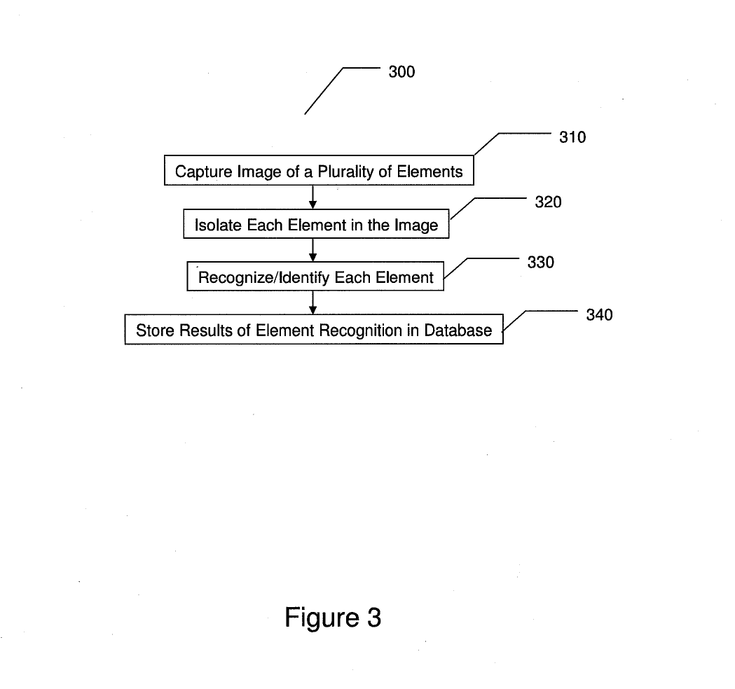

Refer to FIG. 3, which is a flowchart illustrating a graphical recognition inventory management and marketing system according to an embodiment of the present invention.

The graphical recognition inventory management and marketing system 300 begins in Step 310 by capturing an image by an image capture device. The captured image comprises a plurality of product elements. In Step 320 each element of the plurality of elements is isolated. Each element is isolated using, for example, edge sensing, color changes, or height changes. For example, edges or changes in color between elements or between elements and non-element areas are detected and/or changes in height between elements are detected to separate and isolate each element in the captured image.

After an element has been isolated as an individual element, graphical recognition is utilized to identify the element in Step 330. Characteristics of the isolated element are compared with element data stored in the database. For example, text on the element is recognized using optical character recognition (OCR) and the database is searched to find a match between the element text and a database entry.

When a match is found, the captured and isolated element data is stored with the matched database entry in Step 340. For example, the quantity of the matching isolated elements is tracked by the database to determine current inventory. Or, for example, additional element data retrieved during the graphical recognition process is added to element data stored in the database to expand the database entry.

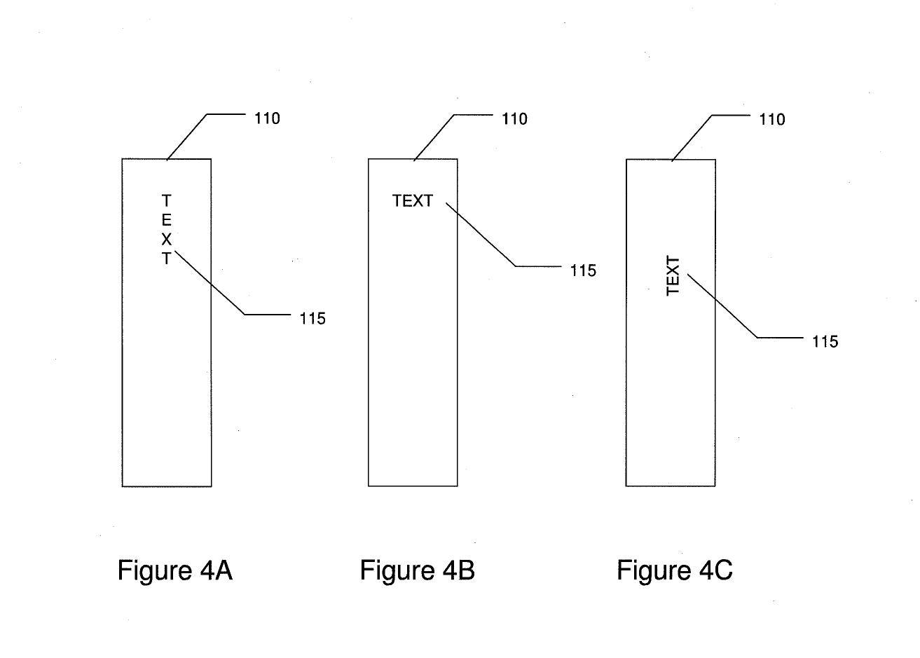

Refer to FIGS. 4A-4C, which are drawings illustrating isolated elements with text according to embodiments of the present invention.

During the graphical recognition process the system of the present invention is capable of detecting and recognizing graphical objects and text in a variety of orientations. For example, the element 110 illustrated in FIG. 4A comprises text 115 oriented vertically, in FIG. 4B the text 115 is horizontal, and in FIG. 4B the text 115 is rotated.

Regardless of the orientation of the graphical object or text in the isolated element image the system successfully detects, identifies, and recognizes the text.

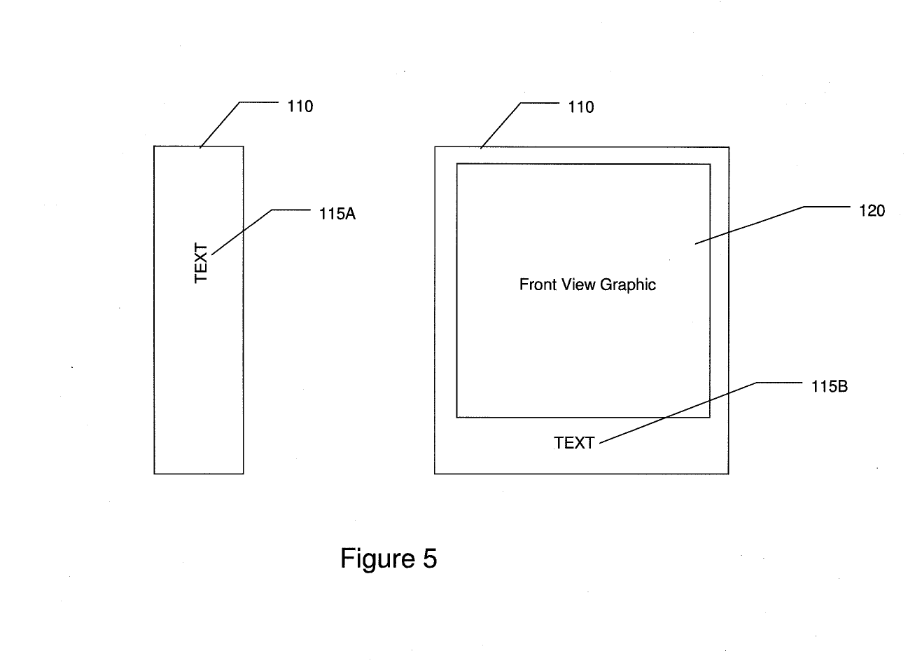

Refer to FIG. 5, which is a drawing illustrating a side and front view of an element according to an embodiment of the present invention.

During the graphical recognition process a variety of element data is collected. For example, colors of the element, text on the element, or graphical objects on the element are determined. After finding a database entry that matches the recognized element additional element data retrieved during the graphical recognition process is added to element data stored in the database to expand the database entry.

For example, the isolated element 110 in the captured image comprises rotated text 115A, element shape, dimensions, and an end view image of the element. The rotated text 115A matches horizontal text 115B stored in a database entry. The stored database entry currently comprises horizontal text 115A, front view shape and dimension, a front view image, and a front view graphic 120. After a successful match, the additional element data is added to the matching database entry element data and associated with the database entry. As a result, the database is continually expanded with additional data.

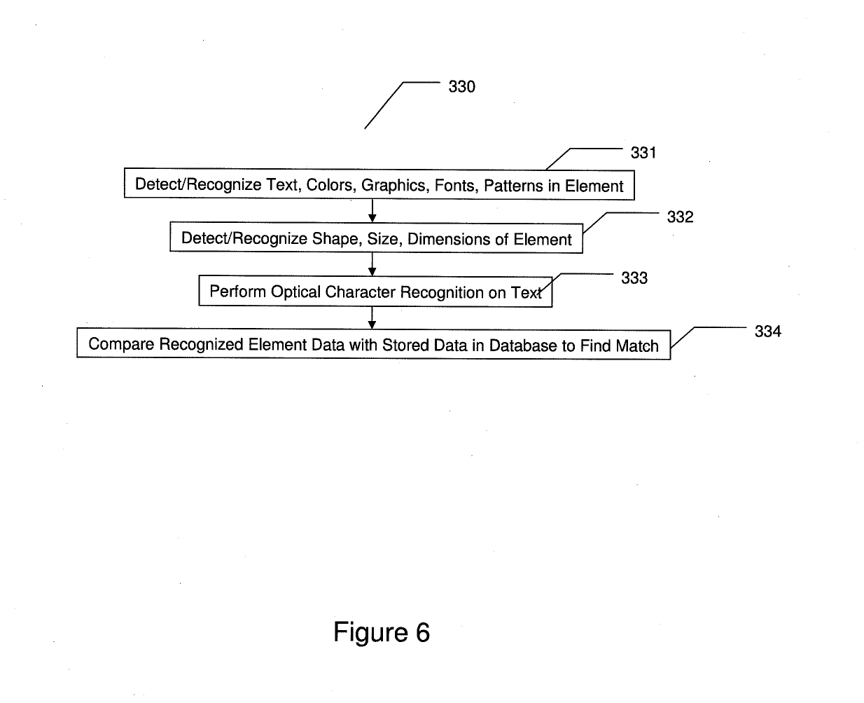

FIG. 6 is a flowchart illustrating an element recognition procedure according to an embodiment of the present invention.

In the embodiment illustrated in FIG. 6 the element recognition procedure 330 (FIG. 3, Step 330) begins by detecting and recognizing element characteristics such as, for example, text, colors, graphics, fonts used in text, and patterns in Step 331. In Step 332 the shape, size, and dimensions of the element are detected and recognized. In Step 333 optical character recognition (OCR) is performed on the detected text. In Step 334 the recognized element data from Steps 331, 332, 333 are compared with stored element data in the database to find a match.

In an embodiment the results of the comparison must be greater than a preset threshold in order to be considered a match.

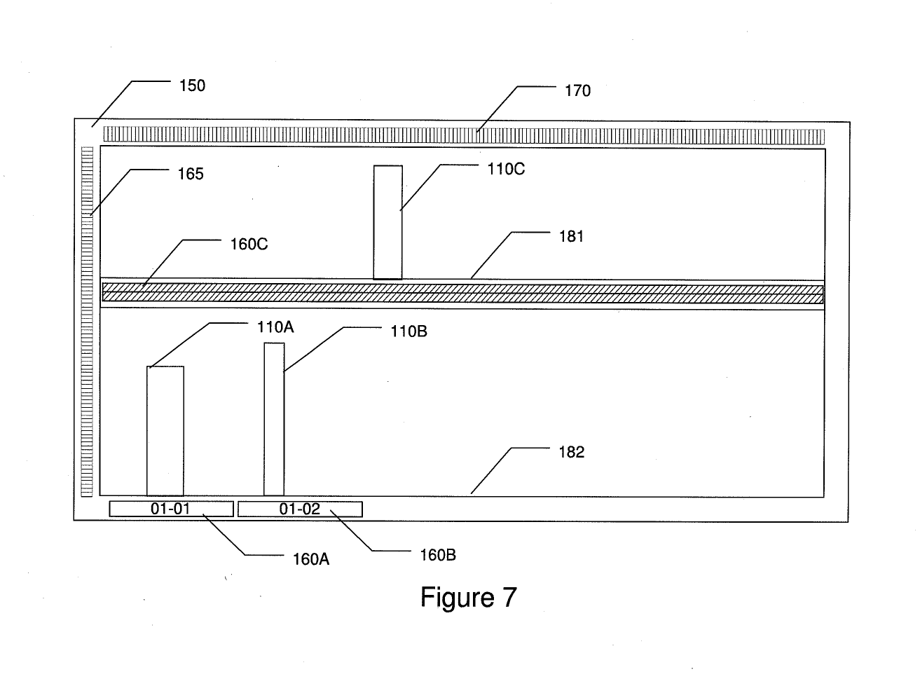

Refer to FIG. 7, which is a drawing illustrating a product shelf with shelf location identification according to an embodiment of the present invention.

The embodiment illustrated in FIG. 7 improves upon the traditional shelf for storing products.

The product shelf 150 comprises a top shelf 180, a middle shelf 181, and a bottom shelf 182. A shelf location identification 160A or a plurality of shelf location identifications 160A, 160B, 160C are disposed on the bottom shelf 182, middle shelf 181, the top shelf 180, or more than one of the shelves. The shelf location identification 180A identifies where product elements 110A, 110B, 110C are physically located on the product shelf 150. The shelf location identification 160A, 160B, 160C also identify where the product shelf 150 is located in the building.

The shelf location identification 160A-160C comprises shelf data such as, for example, where the product shelf 150 is located, which shelf 180-182 of the product shelf 150, and position on the specific shelf of the product shelf 150.

The shelf location identification 160A-160C comprises, for example, numbers, letters, characters, colors, color gradients, distances, measurements, barcodes, or quick response (QR) codes, or other codes recognizable by graphical recognition.

In an embodiment of the present invention the shelf location identification 160C comprises a split identification allowing the shelf location identification 160C to provide shelf data for the product elements on the middle shelf 181 above the shelf location identification 160C and the bottom shelf 182 below the shelf location identification 160C.

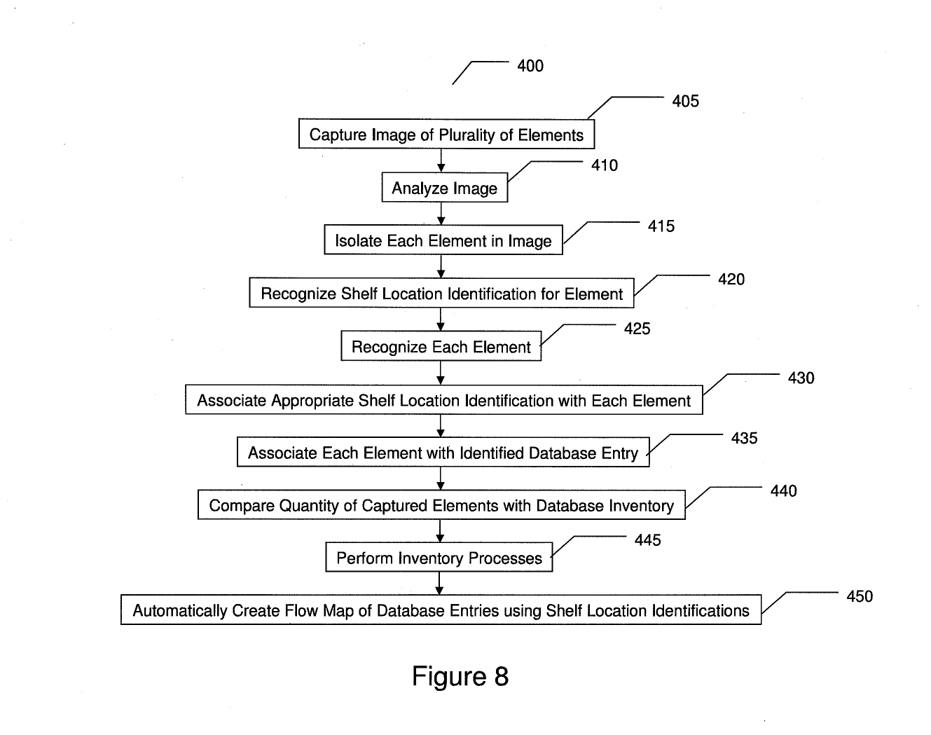

In an embodiment of the present invention the product shelf 150 further comprises a shelf width marker 170 and a shelf height marker 165. The shelf width marker 170 is used for determining width of a product element on the shelf or position of the product element on the shelf. The shelf height marker 165 is used for determining height of a product element on the shelf or which shelf the product element is on. Utilizing the shelf width marker 170 and the shelf height marker 165 the dimensions of product elements can easily be obtained. Refer to FIG. 8, which is a flowchart illustrating a graphical recognition inventory management and marketing system according to an embodiment of the present invention.

In the embodiment illustrated in FIG. 8 the graphical recognition inventory management and marketing system 400 comprises capturing an image of a plurality of elements stored on a product shelf in Step 405 by an image capture device. In Step 410 the image is analyzed and in Step 415 each product element in the captured image is isolated. In addition to the product elements shelf location identifications are captured in the image. The shelf location identification for each element is recognized in Step 420. In Step 425 each isolated element is recognized using graphical recognition and in Step 430 each isolated element is associated with the shelf location identification for the element. The recognized element characteristics are compared with element data stored in the database and each element along with the associated shelf location identification are associated and stored with the matching database element data in Step 435.

The database comprises a total expected quantity in inventory for each element. When there is a plurality of identical elements located on the product shelf, each element recognized and associated with the matching database element data increases the total quantity of the element in the current inventory. In Step 440 the quantity of the captured associated elements in the current inventory is compared with the expected quantity for the element stored in the database. For example, element ABC has a total expected quantity in inventory of 14 stored in the database from a previous inventory result and when a new inventory is undertaken the number of captured associated element ABCs is 12 in the current inventory total.

In Step 445 inventory processes are performed. For example, the total expected quantity is updated using the current quantity in inventory, the difference between the total expected quantity and the current quantity is compared with sales histories for the element, management is alerted to potential theft, or automatic low stock ordering is initiated for the element.

In Step 450 a flow map is automatically created of database entries using the associated shelf location identification for each element. The map is created showing the physical location of the element or elements in the building and on the shelf. Additionally, the map displays the route to the element from a current location of a user.

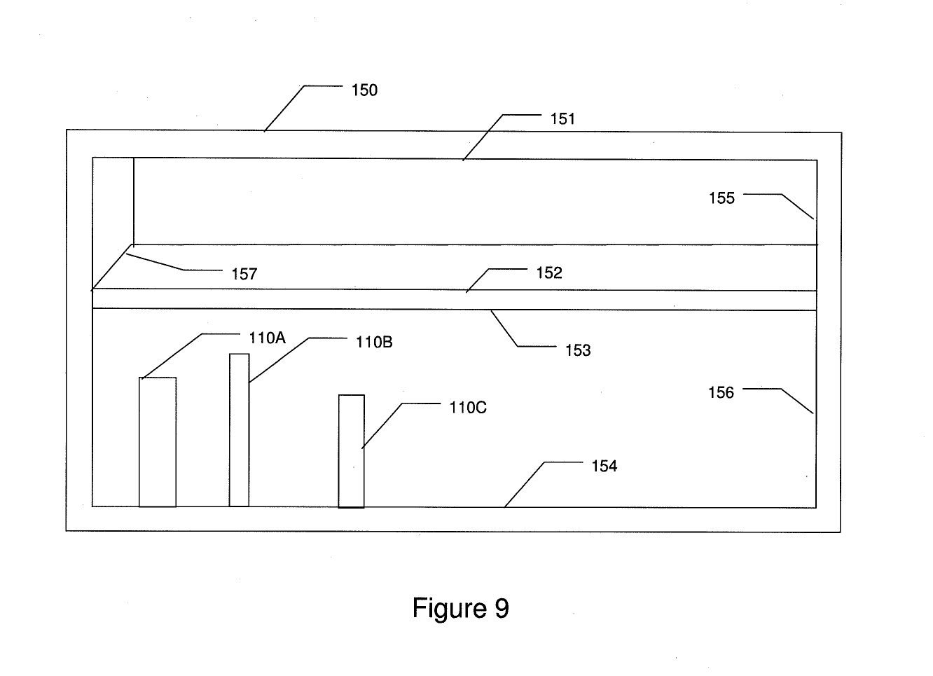

Refer to FIG. 9, which is a drawing illustrating a product shelf according to an embodiment of the present invention.

For a product shelf 150 with known dimensions, the dimensions of the element 110A, 110B, 110C are derived using the distance between shelves, the width of shelves, and the depth of shelves. For example, The middle shelf height 155 between the top shelf bottom 151 and the middle shelf top 152 or the bottom shelf height 156 between the middle shelf bottom 153 and the bottom shelf top 154 as well as the shelf depth 157 and shelf width are known. When the image is captured and the shelf above and below the element are shown, the dimensions of the element are calculated using a ratio or relative size analysis. As a result, the dimensions of the element are automatically obtained and added to the element data in the database. Additionally, the shelf location identification can be used to identify the product shelf 150 dimensions for calculations.

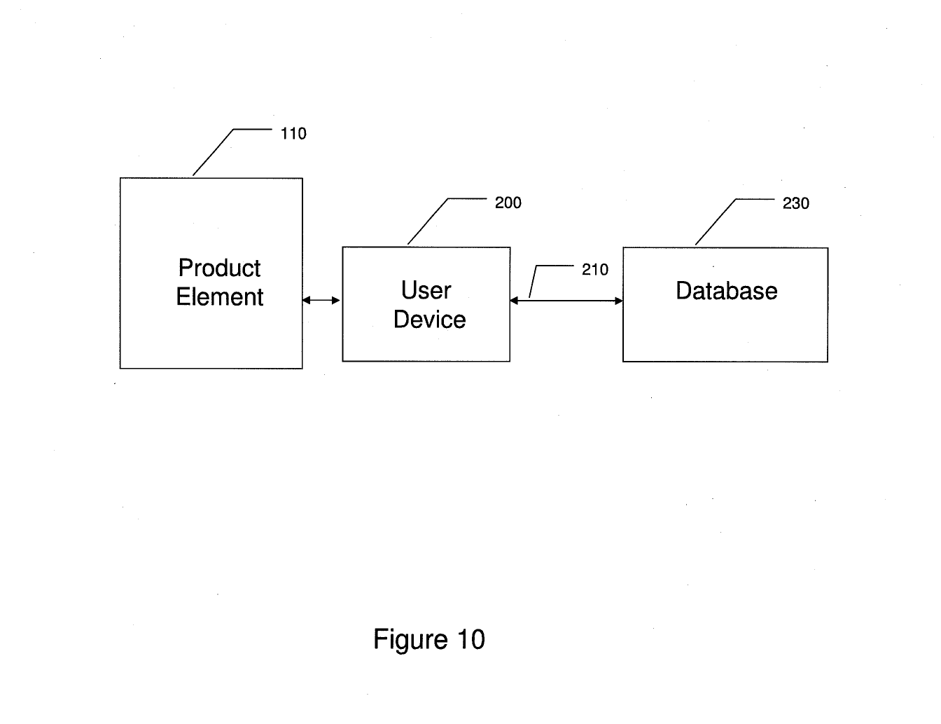

Refer to FIG. 10, which is a drawing illustrating an architecture of a graphical recognition inventory management and marketing system according to an embodiment of the present invention.

Users such as, for example, consumers or warehouse personnel utilize the graphical recognition inventory management and marketing system to interact with a product element 110 and the database 230 using a user device 200. The user device 200 communicates with the database 230 via a wireless communication connection 210. For example, the database 230 provides a map showing the location of and route to the element 110 displayed on the user device 200 or the user device 200 retrieves element data such as price or inventory quantity for the product element 110 from the database 230 to assist the user.

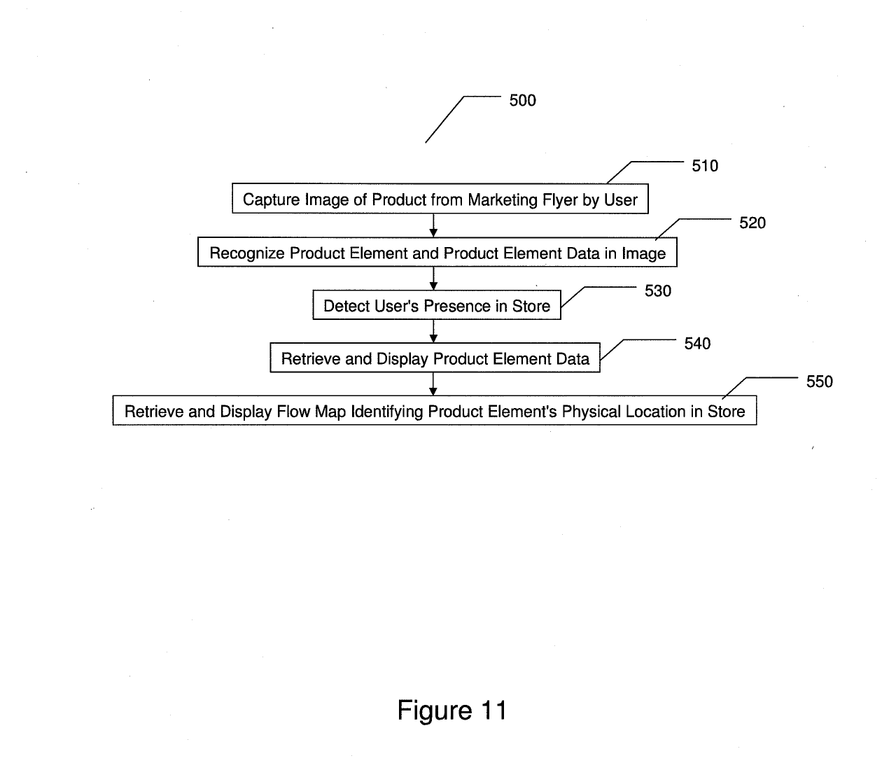

Refer to FIG. 11, which is a flowchart illustrating a graphical recognition inventory management and marketing system according to an embodiment of the present invention.

Retail stores frequently print marketing flyers showing products and prices to entice consumers to visit their store. While useful to consumers for reference, it is inconvenient to carry the flyer to the store or remember which products the consumer intends to purchase.

The graphical inventory and marketing system 500 illustrated in FIG. 11 comprises capturing an image of a product element shown in a marketing flyer by a user utilizing a user device in Step 510. For example, a user can peruse the flyer at home and photograph images of products they wish to purchase. In Step 520 the product element in the image is recognized and product element data such as original price, discount price, brand, logo, product category, or store name are recognized.

In Step 530 the user's presence is detected in the store. For example, when a user enters the store or is inside the store, the location of the user device is detected by wireless means such as using global positioning satellite (GPS), Wi-Fi, Bluetooth, radio frequency identification (RFID), or near field communication (NFC).

In Step 540 the system retrieves and displays the product element and product element data on the user device. Additionally, a flow map showing the product element's physical location in the store and the route from the user's current location to the element's physical location are displayed on the user device in Step 550.

As a result, a user can conveniently take pictures of products they want to purchase shown in a flyer, be reminded of the products when they are at the store, and easily locate the product in the store.

Additionally, marketers can utilize the system to display competing or complementary product information and locations as options for the user.

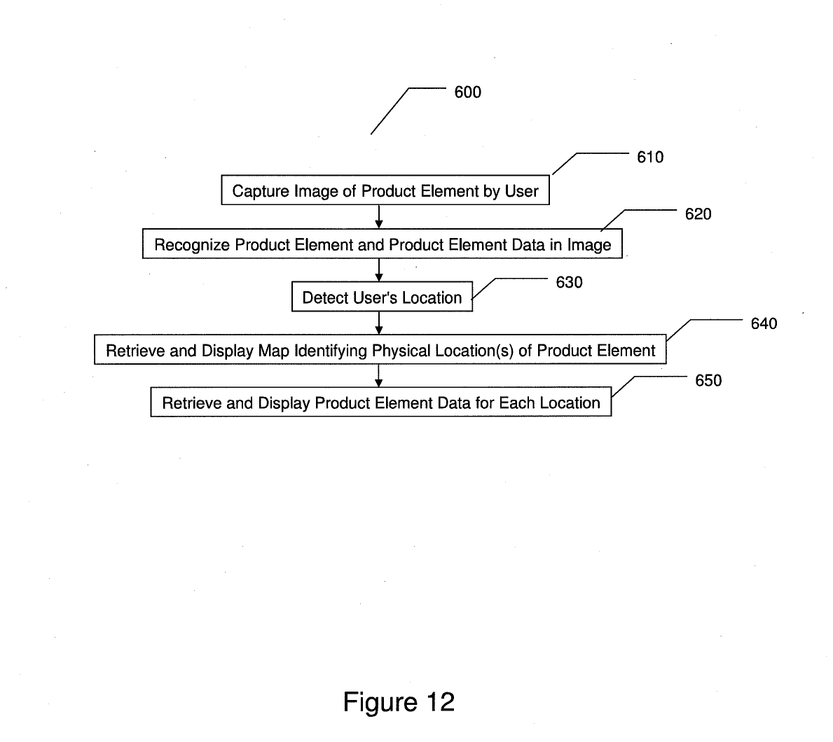

Refer to FIG. 12, which is a flowchart illustrating a graphical recognition inventory management and marketing system according to an embodiment of the present invention.

The graphical recognition inventory management and marketing system 600 illustrated in FIG. 12 comprises capturing an image of a product element by a user utilizing a user device in Step 610. In Step 620 the product element and product element data in the image is recognized. The user's current location is detected in Step 630. In Step 640 a map showing a physical location or physical locations of the product element are retrieved from the database and displayed on the user device. Additionally, product element data for each physical location is retrieved from the database and displayed on the user device in Step 650.

For example of application, a user takes a picture of a computer that they like. The system recognizes the computer by product element data such as color, brand name, shape, dimensions, or model number in the captured image that matches element data stored in the database. When the system detects the user's current location a map is retrieved from the database and displayed on the user's device showing various locations where the computer can be purchased. The map also displays routes to the locations from the user's current location. Additionally, the user device displays data such as price, additional models, or competing product information for each location so the user can choose between vendors or products.

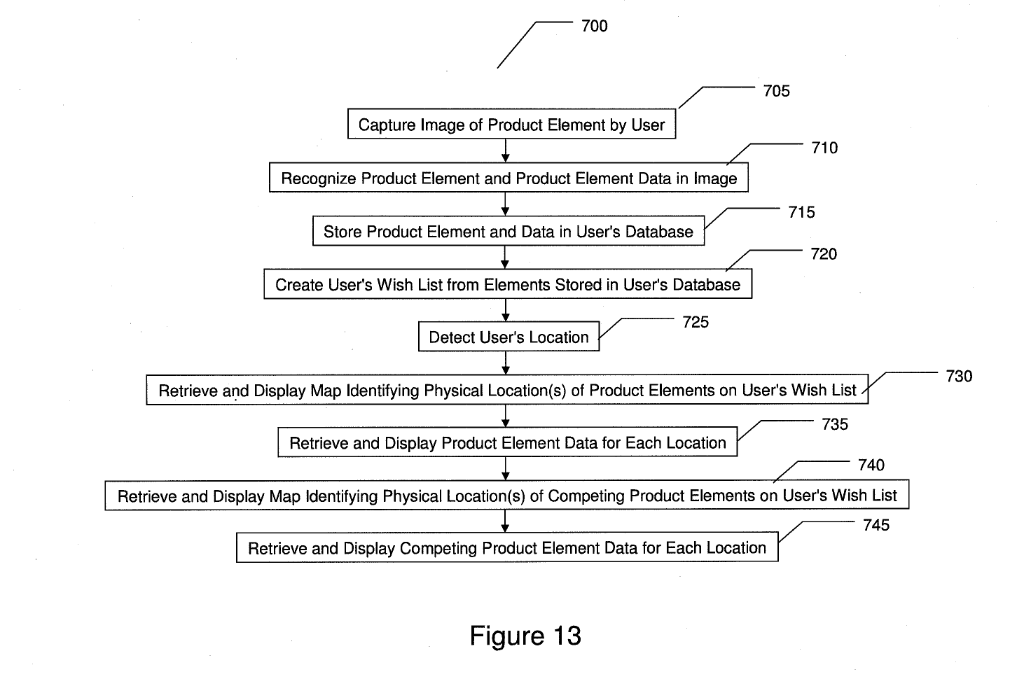

Refer to FIG. 13, which is a flowchart illustrating a graphical recognition inventory management and marketing system according to an embodiment of the present invention.

The graphical recognition inventory management and marketing system 700 comprises capturing an image of a product element by a user in Step 705. In Step 710 the product element and product element data in the image are recognized. The product element and data are stored in the user's database in Step 715. In Step 720 a user's wish list is created and maintained from elements stored in the user's database. The wish list allows the user to be reminded of items they want to purchase or let other users see what the user wants and other user's can purchase the element for the user as a gift.

In Step 725 the user's location is detected. A map indicating physical location(s) of the product elements on the user's wish list is retrieved and displayed on the user's device in Step 730. In Step 735 product element data for each location is retrieved and displayed. In Step 740 a map indicating physical location(s) of competing products similar to the product elements on the user's wish list is retrieved and displayed on the user's device. In Step 745 competing product element data for each location is retrieved and displayed.

Users have the option to share their wish list with other users. When the wish list is shared, other users are notified on their map indicating physical locations of the product element as in Step 735. In this way, users know what products other users want and be notified of locations near them where they can purchase the product element. Not only does this embodiment increase the social network value and increase the satisfaction of gift exchanging but also eliminates physical location restrictions.

For example, user A photographs and places an element on their wish list that is not available in user A's city and user B is in another city where the element is available. User B can easily make the purchase for user A and ship the element to user A.

As a result of eliminating location restrictions the system of the present invention allows an international social network to develop for users thereby increasing the value of the social network and expanding the network to a business network as well.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A graphical recognition inventory management and marketing system comprising:
capturing an image of a plurality of elements stored on a product shelf;
analyzing the image;
isolating an element of the plurality of elements;
recognizing a shelf location identification on the product shelf for the element;
recognizing the element and element data of characteristics of the element;
associating the shelf location identification with the element;
searching a database for a stored database entry matching the element and the element data;
associating the stored database entry matching the element and the element data with the element; and
storing the element data in the database with the stored database entry matching the element and the element data.

2. The graphical recognition inventory management and marketing system of claim 1, further comprising:
performing optical character recognition on text data of the element data.

3. The graphical recognition inventory management and marketing system of claim 1, further comprising:
creating a flow map of the element using the shelf location identification indicating a physical location of the element.

4. The graphical recognition inventory management and marketing system of claim 1, the shelf location identification comprising numbers, letters, characters, colors, color gradients, distances, measurements, barcodes, quick response (QR) codes, or other codes recognizable by graphical recognition that identify location of the product shelf, a specific shelf of the product shelf, and position on the specific shelf of the product shelf.

5. The graphical recognition inventory management and marketing system of claim 1, further comprising:
a shelf width marker for determining width and position of the element on a shelf of the product shelf; and
a shelf height marker for determining height of the element on the shelf and which shelf the element is on.

6. The graphical recognition inventory management and marketing system of claim 1, further comprising:
associating additional element data obtained from the image with the stored database entry matching the element.

7. The graphical recognition inventory management and marketing system of claim 1, the step of recognizing the element comprising:
detecting text, colors, graphics, fonts, and patterns in the element
detecting shape, size, and dimensions of the element;
performing optical character recognition on text in the element; and
comparing recognized element data with stored element data in the database to find a match.

8. The graphical recognition inventory management and marketing system of claim 1, the element data comprising brand name, product name, cost, price, current inventory level, size, shape, dimensions, weight, logo, manufacturer, supplier, color, design, graphics, images, text, total cost of current inventory, shelf location identification, product number, barcode, or other data of identifying characteristics of the product

9. The graphical recognition inventory management and marketing system of claim 1, further comprising:
detecting a current location of a user device;
retrieving from the database and displaying the element and the element data on the user device; and
retrieving from the database and displaying a flow map indicating a physical location of the element and a route to the physical location from the current location of the user device.

10. The graphical recognition inventory management and marketing system of claim 1, further comprising:
capturing a flyer product element image by a user device;
recognizing a flyer product element in the flyer product element image;
detecting presence of the user device in a store;
displaying on the user device the element data stored in the database matching the flyer product element; and
displaying on the user device a flow map indicating a physical location of the flyer product element in the store and a route to the physical location from a current location of the user device.

11. The graphical recognition inventory management and marketing system of claim 1, further comprising:
capturing a user product element image by a user device;
recognizing a user product element in the user product element image;
detecting a current location of the user device;
displaying on the user device the element data stored in the database matching the user product element; and
displaying on the user device a flow map indicating a plurality of physical locations of the product element and a route to the physical locations from a current location of the user device.

12. The graphical recognition inventory management and marketing system of claim 1, further comprising:
capturing a user product element image by a user device;
detecting element data in the user product element image;
recognizing the element from the element data;
storing the element and the element data in a user's entry in the database;
associating elements in the user's entry with matching element data in the database;
creating a user wish list of elements in the user's entry in the database;
detecting a current location of the user device;
displaying on the user device a map indicating physical locations of elements on the user wish list; and
displaying on the user device element data stored in the database matching the element on the wish list for each physical location.

13. The graphical recognition inventory management and marketing system of claim 12, further comprising:
a route to the physical locations from a current location of the user device.

14. The graphical recognition inventory management and marketing system of claim 12, further comprising:
displaying on the user device a map indicating physical locations of competing elements similar to elements on the user wish list; and
displaying on the user device element data stored in the database matching the competing elements for each physical location.

15. The graphical recognition inventory management and marketing system of claim 12, further comprising:
sharing the user wish list with other users to allow the other users to interact with the user wish list.

16. A graphical recognition inventory management and marketing system comprising:
capturing an image of a plurality of elements stored on a product shelf;
analyzing the image;
isolating an element of the plurality of elements;
recognizing a shelf location identification on the product shelf for the element;
recognizing the element and element data of characteristics of the element;
associating the shelf location identification with the element;
searching a database for a stored database entry matching the element and the element data;
associating the stored database entry matching the element and the element data with the element;
storing the element data in the database with the stored database entry matching the element and the element data;
creating a flow map of the element using the shelf location identification indicating a physical location of the element;
capturing a flyer product element image by a user device;
recognizing a flyer product element in the flyer product element image;
detecting presence of the user device in a store;
displaying on the user device element data stored in the database matching the flyer product element; and
displaying on the user device a flow map indicating a physical location of the flyer product element in the store and a route to the physical location from a current location of the user device.

17. The graphical recognition inventory management and marketing system of claim 16, further comprising:
displaying on the user device complementary element data to the flyer product element; and
displaying on the user device a map indicating physical locations of complementary elements to the flyer product element.

18. The graphical recognition inventory management and marketing system of claim 16, further comprising:
displaying on the user device competing element data to the flyer product element; and
displaying on the user device a map indicating physical locations of competing elements to the flyer product element.

19. A graphical recognition inventory management and marketing system comprising:
capturing an image of a plurality of elements stored on a product shelf;
analyzing the image;
isolating an element of the plurality of elements;
recognizing a shelf location identification on the product shelf for the element;
recognizing the element and element data of characteristics of the element;
associating the shelf location identification with the element;
searching a database for a stored database entry matching the element and the element data;
associating the stored database entry matching the element and the element data with the element;
storing the element data in the database with the stored database entry matching the element and the element data;
creating a flow map of the element using the shelf location identification indicating a physical location of the element;
capturing a user product element image by a user device;
recognizing a user product element in the user product element image;
detecting a current location of the user device;
displaying on the user device element data stored in the database matching the user product element; and
displaying on the user device a flow map indicating physical location of the user product element and a route to the physical location from the current location of the user device.

20. The graphical recognition inventory management and marketing system of claim 19, further comprising:
displaying on the user device competing element data to the user product element and a map indicating physical locations of competing elements to the user product element; and
displaying on the user device complementary element data to the user product element and a map indicating physical locations of complementary elements to the user product element.
